(19) United States
(12) Patent Application Publication
(10) Pub. No.: US 2013/0094323 A1
(43) Pub. Date: Apr. 18, 2013

(54) MIXER FOR PULP-AND FIBER-CONTAINING BEVERAGES

(71) Applicant: KRONES AG, Neutraubling (DE)

(72) Inventor: Erwin Engel, Donaustauf (DE)

(73) Assignee: KRONES AG, Neutraubling (DE)

(21) Appl. No.: 13/654,494

(22) Filed: Oct. 18, 2012

(30) Foreign Application Priority Data
Oct. 18, 2011 (DE) 102011084720.0

(51) Int. Cl. B01F 5/12; B01F 15/02; B01F 15/06

(52) U.S. Cl. 366/144; 366/262; 366/184

(57) ABSTRACT

A device for mixing a pulp- and/or fiber-containing fluid which comprises an apparatus for moving the fluid free from shearing, and a corresponding method.

### CROSS-REFERENCE TO RELATED APPLICATION

The present application claims the benefit of priority of German Application No.102011084720.0, filed Oct. 18, 2011. The entire text of the priority application is incorporated herein by reference in its entirety.

### FIELD OF THE DISCLOSURE

The present disclosure relates to a device and a method for mixing a pulp- and/or fiber-containing fluid.

### BACKGROUND

The majority of beverage mixers are designed as two-component mixers wherein a previously prepared finished syrup is mixed with degassed water, and the resulting mixture is additionally cooled and blended, for example, with CO₂, N₂O, N₂, O₂, if required. The finished beverage is supplied to a filling machine or a heater system, respectively.

The described machines are, according to prior art, designed using centrifugal pumps, control and shut-off valves as well as plate heat exchangers. These components are an obstacle to the processing of beverages with solid matters as they either do not tolerate the solid ingredients, such as for example pieces of fruit pulp (due to small gap widths), or even have a destroying effect on these solid ingredients, in particular fibers. The mentioned conveying and control elements are always required when, in hydraulically coupled systems, a conveying task with additional pressure increase must be fulfilled, for example to introduce a gas into the beverage.

Furthermore, especially in the field of products containing solid matter, one can observe that by trend, more expensive products are produced in rather small batches. This results in frequent product changes involving the corresponding loss due to mixing zones. The designed container volumes are normally not sufficient to advance or push out e. g. the contents of a complete syrup conduit in one go. However, this is desirable in view of a mixing zone kept at a minimum; it assists in compensating for the deficiencies of the installation on site, avoids standstills in case of a temporary failure of syrup supply and avoids adulteration of dosage in case of varying feed conditions. Furthermore, the mentioned machines do not offer any mechanism that ensures that the syrup contents of the syrup supply conduit can be actually utilized at 100%. For this, it would be necessary to additionally accept the complete mixing zone from water to syrup and back plus a certain amount of water as “syrup”.

In plants constructed nowadays, it is moreover increasingly demanded that the mixing quantities of product discharges of downstream plant parts are not discarded but added again to the product origination branch at a suited point. This working method is neither mastered by presently common mixers, though it is increasingly desired especially with products containing solid matter.

A further operator's demand is to minimize the CO₂ consumption of the carbonation apparatus as far as possible, in particular in intermittent operations or in the processing of packs leading to a product decrease to below the control range of the mixer. In common machines, this claim always collides with the property of operating the product container as an empty buffer, together with the property of fresh gas addition with carbonation gas.

### SUMMARY OF THE DISCLOSURE

In view of the above-noted disadvantages of the prior art, it is one aspect of the present disclosure to provide a device and a method for mixing a pulp- and/or fiber-containing fluid which are efficient and gentle to the product.

The above aspect is achieved by a device for mixing a pulp- and/or fiber-containing fluid comprising an apparatus for moving the fluid free from shearing. An impairment of the pulp and/or fiber dimensions due to edges of the conventional apparatus for moving the pulp- and/or fiber-containing fluid that move against each other is avoided in this manner.

According to a further development of the device according to the disclosure, the apparatus for moving the fluid free from shearing can comprise a first positive-displacement pump, in particular a first reciprocating or screw pump. Thus, for example usually employed centrifugal pumps can be eliminated which comprise shearing points and can cut through fibers. In contrast, a positive-displacement pump is free from such shearing points and can be designed, for example, as reciprocating pump or as screw pump.

According to a further development, the apparatus for moving the fluid free from shearing can comprise a second positive-displacement pump, in particular a second reciprocating or screw pump; wherein the first or the second positive-displacement pump can be operated as pushing pump, and the second or the first positive-displacement pump can be operated as braking pump, whereby in the operation of the device, a pressure increase of the fluid between the two positive-displacement pumps can be achieved. Thus, a pressure increase can be achieved in a manner that is gentle to the pulp or fibers (e. g. for carbonation) without using centrifugal pumps which in this case would have to be operated at high speeds that have damaging effects on the product, namely the pulp- and/or fiber-containing fluid.

A further development consists in an apparatus being provided for introducing a gas into the fluid located, in the operation of the device, between the first and the second positive-displacement pumps, in particular an apparatus for carbonating the fluid. In this manner, a gas, such as CO₂, can be introduced into the fluid. This apparatus normally comprises a dosing conduit. If several gases are to be supplied, more dosing conduits are provided correspondingly.

According to the present disclosure, the apparatus for moving the fluid free from shearing can be free from control valves. By the elimination of control valves, further pulp or fiber damaging effects due to small gap widths can be avoided.

According to yet a further development, the device can be designed to mix the pulp- and/or fiber-containing fluid at least from water, in particular degassed water, and one or several pulp- and/or fiber-containing components.

In another development, the device can furthermore comprise a mixing container for receiving at least a part of the pulp- and/or fiber-containing fluid, wherein the mixing container comprises an inlet and an outlet via which, in the operation of the device, a circulation of the fluid is accomplished, in particular wherein the outlet is connected to the inlet via a return conduit with a circulation pump. By this, a deposition of the pulp is prevented, and the agitation function is permitted already at low filling levels. The attached circulation apparatus moreover always keeps solid ingredients in suspension and homogenizes the contents of the container.

The device can moreover comprise an apparatus for supplying water as an input component of the fluid and an apparatus for cooling the water. The arrangement of the cooler in the water branch transfers the cooling job to a point where no pulp and fibers occur. By this, the use of expensive tubular apparatuses, which would be required in the mixture region according to prior art, is avoided.

According to a further development, at least one presettling tank for receiving a pulp- and/or fiber-containing input component of the fluid can be moreover provided, where the presettling tank can be dimensioned such that the complete contents of a dosing conduit for the pulp- and/or fiber-containing starting component can be received therein, the dosing conduit being provided between the presettling tank and an inlet point at the return conduit, and the inlet point preferably being an inlet valve. Thus, during starting and shutting down the plant, the container can receive, thanks to its size, for example the mixing zones of syrup with water plus a certain quantity of pure water. In both cases, apart from the contents of the dosing conduit (syrup conduit), the contents of the container can also be used.

In another development, the device can moreover comprise a discharge pump which is disposed at such a height that, in the operation of the device, other fluid-carrying components of the device can run empty to the discharge pump. This ensures that the device can be emptied essentially free from any residues.

The above mentioned aspect is furthermore achieved by a method for mixing a pulp- and/or fiber-containing fluid, in particular a pulp- and/or fiber-containing beverage, comprising the following step: moving the fluid free from shearing. The advantages already mentioned for the device according to the disclosure here apply correspondingly.

The method according to the disclosure can be carried out in accordance with the further developments of the device.

### BRIEF DESCRIPTION OF THE DRAWINGS

Further features and exemplary embodiments as well as advantages of the present disclosure will be illustrated more in detail hereinafter with reference to the drawings. It will be understood that the embodiments do not exhaust the field of the present disclosure. It will be furthermore understood that some or all features described below can also be combined with each other in a different way.

### DRAWINGS

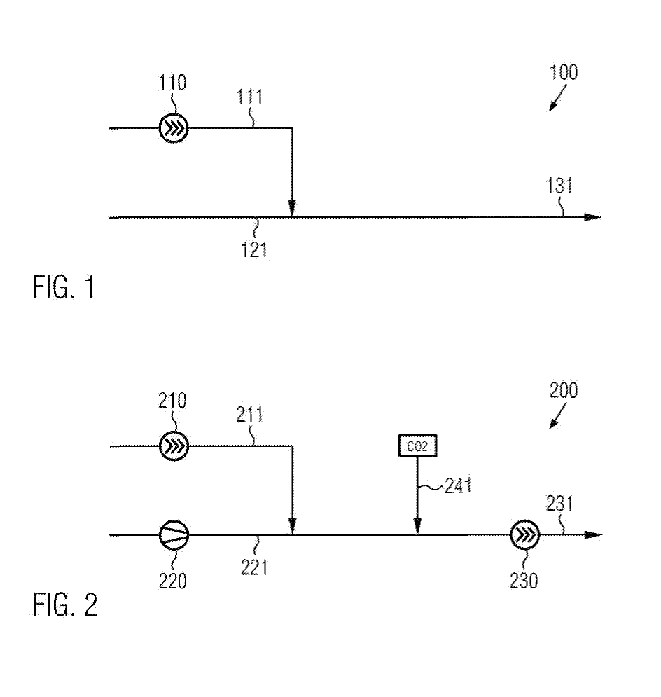

FIG. 1 represents a first embodiment of the device according to the disclosure.

FIG. 2 represents a second embodiment of the device according to the disclosure.

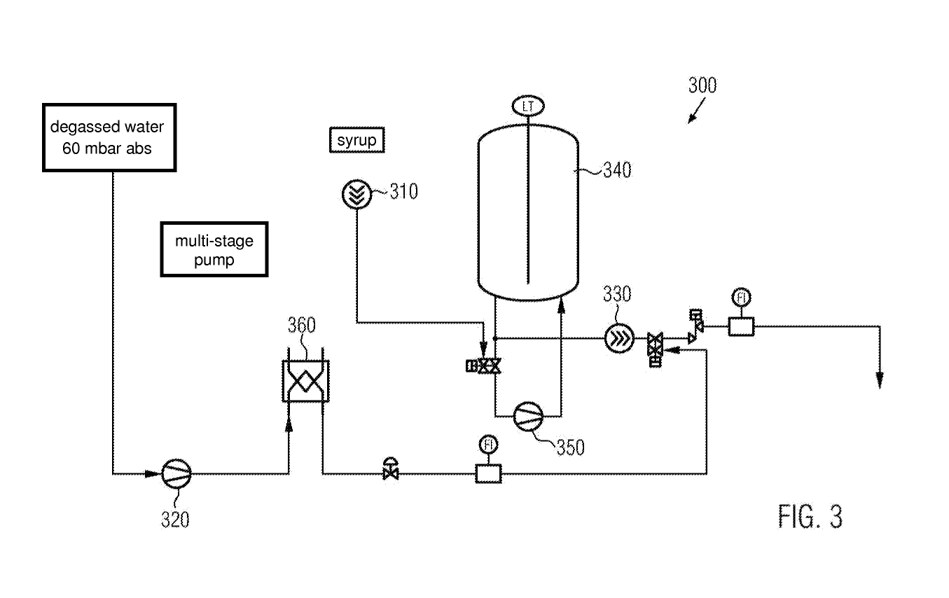

FIG. 3 represents a third embodiment of the device according to the disclosure.

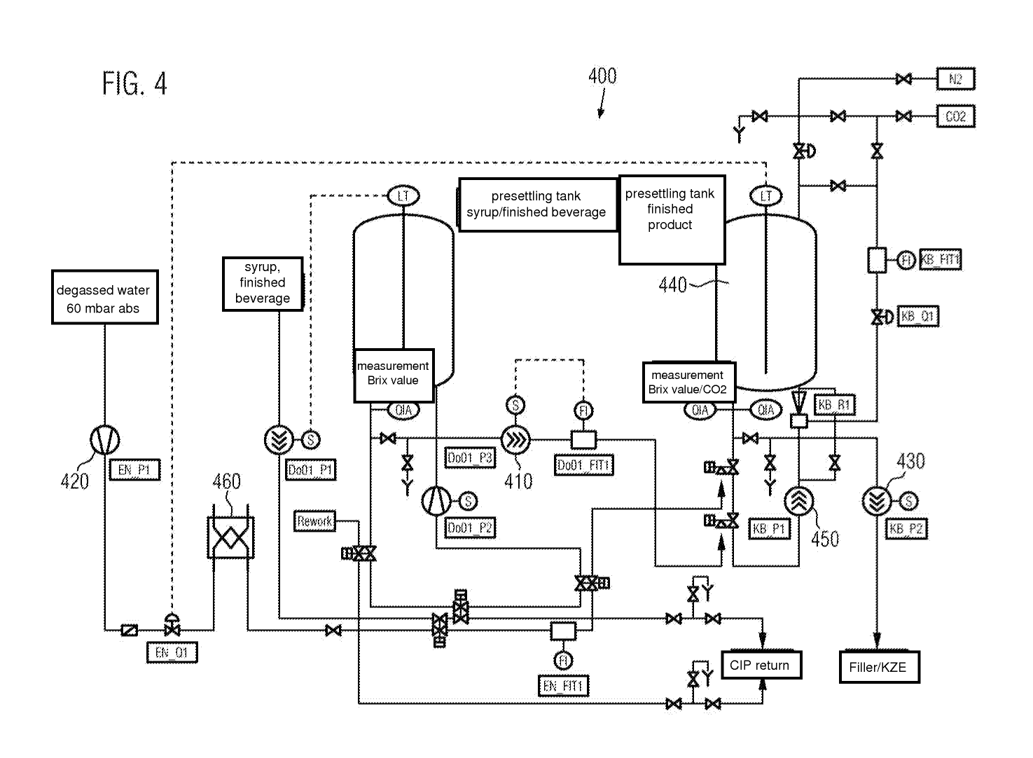

FIG. 4 represents a fourth embodiment of the device according to the disclosure.

### DETAILED DESCRIPTION OF THE PREFERRED EMBODIMENTS

FIG. 1 shows a first embodiment 100 of the device according to the disclosure. The device 100 for mixing a pulp or fiber containing fluid in this case comprises a conduit 121 for water supply. To this water, syrup containing fruit pulp is then added from a conduit 111. This syrup is conveyed by means of a positive-displacement pump 110, e. g. in the form of a screw pump. The mixed fruit juice beverage is then further guided via the conduit section 131, for example to a filling line.

FIG. 2 shows a second embodiment 200 of the device according to the disclosure. The beverage mixer 200 represented therein comprises, apart from the components shown in FIG. 1, a pump 220 for the (preferably degassed) water, the pump 220 being designed here as a centrifugal pump 220. Furthermore, a second positive-displacement pump 230 for further transporting the mixed fluid is provided. Between the pumps 210 and 230, CO₂ is supplied to the fluid via a conduit 241, that means carbonation is performed. Between the two pumps 210 and 230 (and also via the pump 220), pressure is built up by operating the first pump 210 with a pushing effect and the second pump 230 with a braking effect. In this manner, the fluid can take up carbon dioxide.

FIG. 3 shows a third embodiment 300 of the device according to the disclosure. In contrast to the embodiments according to FIGS. 1 and 2, here a mixing container 340 is in particular provided. A further pump 350 takes care of a circulation of the mixed pulp or fiber containing fluid, wherein this pump can also be designed as centrifugal pump as it is operated at low speed and thus no, or hardly any fiber destroying effect is present. Moreover, a cooling device 360 for cooling the supplied degassed water is provided. Various valves not described more in detail here constitute the connection of individual pipe systems.

FIG. 4 shows a fourth embodiment 400 of the device according to the disclosure. In contrast to the embodiment according to FIG. 3, further components are provided here. These are in particular the following ones:

EN_P1: Supply pump for (degassed) water

EN_Q1: Control valve for water supply

EN_FIT1: Flow meter for (degassed) water

Do01_P1: Supply pump for syrup/finished beverage

Do01_P2: Circulation pump for syrup/finished beverage (centrifugal pump, low speed)

Do01_P3: Dosing pump syrup/finished beverage

Do01_FIT1: Flow meter for syrup/finished beverage

KB_P1: Circulation pump/carbonation pump for finished product

KB_P2: Discharge pump for finished product

KB_R1: Injector for gas introduction (can be replaced by a “braking pump”)

KB_FIT1: Flow meter for gas for gas introduction

KB_Q1: Control valve for gas for gas introduction

LT: Level sensor

In the figures, reference numerals only differing by the hundreds digit designate corresponding components.

It should be noted that the elimination of control valves for product control and the use of positive-displacement pumps at points where pressure increase is required prevents an impairment of the pulp and fiber dimensions.

Centrifugal pumps are only employed according to the disclosure where only circulation is essential while lowest pressures are built up. By this, they can run very slowly and therefore do not damage the product.

The device according to the disclosure permits to ensure the inflow, outflow and circulation with only two openings in the container bottom, the circulation being an important unit and replacing the otherwise employed agitators. By this, a deposition of the pulp is prevented and the agitation function is permitted already at such low filling levels that the operation of an agitator is not yet possible.

The arrangement of the cooler in the water branch transfers the cooling job to a point where no pulp and fibers occur and thus avoids the use of expensive tubular apparatuses that would be necessary in the mixture region.

The shown arrangement guarantees that none of the positive-displacement pumps can hydraulically “bottom out” in any operating mode. A corresponding air vessel is always available. Thereby, one can do without product damaging centrifugal pumps also at those points where they would be otherwise indispensible due to hydraulic properties.

The enlarged syrup presettling tank can receive the complete contents of the syrup conduit. The attached circulation apparatus even keeps solid ingredients always in suspension and homogenizes the contents of the container, so that fluctuations in the syrup are brought to a gradient that can be leveled by the dosing apparatus.

When the plant is started and shut down, the container can, due to its size, accept the mixing zones of syrup with water plus a certain quantity of pure water and offers the possibility of thickening the contents of the tank towards the original syrup (start of production) or dilute it to beverage strength (end of production). In both cases, apart from the contents of the syrup conduit, the contents of the container can also be used each at 100%; no rejected quantities occur.

The selection of the measuring devices for the Brix value (quantity for the soluble dry substance in liquid) ensures that also a light syrup or product can be measured so exactly that a control of the mixing ratio is possible with the obtained measured values.

The arrangement of the pipe system and the pumps at the containers is designed such that the discharge pump is located at the lowermost position and all other parts of this assembly can run empty towards it. This ensures that the assembly can be scooped out practically without any residues (except for adhering quantities).

By the use of positive-displacement pumps in the syrup outlet, even in the last product discharge, the mixing zone is minimized. If the mixture is correspondingly controlled, one can even in this part of the plant completely purge out any syrup by thickening the dosage just before the end of the scooping process to then immediately compensate with additional water. This can be done in such a manner that the syrup conduit becomes completely free from syrup up to behind the dosing point.

By the arrangement of the dosing conduits for liquid and gaseous ingredients, it is ensured that at any time any of the components involved can be added in doses. This essentially increases product safety.

By the shown attachment of a carbonator, three effects are obtained. 1. The container can be filled with the mixture, the remaining small headspace can be purged with a minimum use of CO₂ or another span gas to expel air. 2. Carbonation can be done with gas from the headspace whereby in a reduced output operation, the respiration of the container and thus any CO₂ loss can be largely reduced. 3. By circulation, the product is thoroughly mixed, control operations are smoothed out, and in case of subsequent dosing processes, the container's contents is subsequently homogenized. When the plant stands still, the contents of the container can be agitated in intervals.

When only non-carbonated products are processed, the involved containers can be unpressurized, however sealing off against the penetration of outside air is necessary. In this case, the circulation pump of the product container can be designed as a centrifugal pump to permit the mentioned effects 1 and 3 from the above list.

With the arrangement shown in FIG. 4, rework, that means mixing phases occurring in operation, can be easily processed along with unknown, also varying properties. On this side, the need for homogenization of the rework portion is eliminated. The shown arrangement moreover masters the mode of operation of processing rework of unknown intensity with water and/or syrup (or overly thickened finished product).

The shown arrangement finally permits to use the supply conduits for syrup and rework as a supply for the CIP liquid or clean it in a separate CIP circuit, wherein the required medium separation is ensured (CIP=Cleaning in Place).

A further property is not shown in the arrangement, which is the possibility of designing the product conduit in some sections as double tube, whereby further cooling or keeping cool during a standstill can be ensured.

1. A device for mixing a pulp- and/or fiber-containing fluid, comprising:
an apparatus for moving the fluid free from shearing.

2. The device according to claim 1, wherein the apparatus for moving the fluid free from shearing comprises a first positive-displacement pump.

3. The device according to claim 2, wherein the apparatus for moving the fluid free from shearing comprises a second positive-displacement pump; and wherein the first or the second positive-displacement pump can be operated as a pushing pump, and the second or the first positive-displacement pump can be operated as a braking pump, whereby in the operation of the device, a pressure increase of the fluid between the two positive-displacement pumps can be achieved.

4. The device according to claim 3, and further comprising:
an apparatus for introducing a gas into the fluid located, in the operation of the device, between the first and the second positive-displacement pumps.

5. The device according to claim 1, wherein the apparatus for moving the fluid free from shearing is free from control valves.

6. The device according to claim 1, wherein the device for mixing is designed to mix the pulp- and/or fiber-containing fluid at least from water and one or several pulp- and/or fiber-containing components.

7. The device according to claim 1, and further comprising a mixing container for receiving at least a part of the pulp- and/or fiber-containing fluid, wherein the mixing container comprises an inlet and an outlet via which, in the operation of the device, a circulation of the fluid is effected.

8. The device according to claim 1, and further comprising an apparatus for supplying water as an input component of the fluid and an apparatus for cooling the supplied water.

9. The device according to claim 1, and further comprising at least one presettling tank for receiving a pulp- and/or fiber-containing input component of the fluid.

10. The device according to claim 1, and further comprising a discharge pump which is disposed at such a height that, in the operation of the device, other fluid-carrying components of the device can run empty towards the discharge pump.

11. A method of mixing a pulp- and/or fiber-containing fluid, comprising
moving a fluid free from shearing.

12. The device according claim 2, wherein the first positive-displacement pump is one of a final piston pump or a first screw pump.

13. The device according to claim 3, wherein the second positive-displacement pump is one of a second reciprocating pump or a second screw pump.

14. The device according to claim 4, wherein the apparatus for introducing a gas is an apparatus for carbonating the fluid.

15. The device according to claim 7, wherein, for effecting the circulation of the fluid, the outlet is connected to the inlet via a return conduit with a circulation pump.

16. The device according to claim 9, wherein the presettling tank is dimensioned such that the complete contents of a dosing conduit for the pulp- and/or fiber-containing input component can be received therein, wherein the dosing conduit is provided between the presettling tank and an inlet point at the return conduit, and wherein the inlet point is an inlet valve.

17. The method according to claim 11, wherein the pulp-and/or fiber-containing fluid is a pulp- and/or filter-containing beverage.
